(19) United States
(12) Patent Application Publication
(10) Pub. No.: US 2016/0226618 A1
(43) Pub. Date: Aug. 4, 2016

(54) CONTROLLING METHOD FOR MITIGATING ROGUE OPTICAL NETWORK UNIT (ONU) IN HYBRID PASSIVE OPTICAL NETWORK (PON) SYSTEM

(71) Applicant: Electronics and Telecommunications Research Institute, Daejeon (KR)

(72) Inventors: Jie-Hyun LEE, Daejeon (KR); Kyeong-Hwan DOO, Daejeon (KR); Sil-Gu MUN, Daejeon (KR); Han-Hyub LEE, Daejeon (KR)

(73) Assignee: Electronics and Telecommunications Research Institute, Daejeon (KR)

(21) Appl. No.: 14/261,041

(22) Filed: Apr. 24, 2014

(30) Foreign Application Priority Data
Apr. 24, 2013 (KR) 10-2013-0045738
May 16, 2013 (KR) 10-2013-0055998
Apr. 21, 2014 (KR) 10-2014-0047692

(51) Int. Cl. H04J 14/02; H04J 14/08; H04B 10/572; H04B 10/27

(52) U.S. Cl. CPC H04J 14/0223; H04B 10/27; H04J 14/08; H04J 14/0221; H04B 10/572

(57) ABSTRACT

A controlling method for mitigating a rogue behavior of an Optical Network Unit (ONU) having a wavelength-tunable function in a hybrid Passive Optical Network (PON) system. The controlling method includes determining whether a first wavelength for an upstream signal received from the ONU strays away from an allowable range for a second wavelength assigned to the ONU, and, in response to a determination that the first wavelength strays away from the allowable range for the second wavelength, transmitting an upstream wavelength adjustment request message to the ONU to adjust a wavelength for the upstream signal. At this point, a determination on whether the first wavelength strays away from the allowable range for the second wavelength is made by calculating wavelength drift of the first wavelength and determining whether the calculated wavelength drift is greater than a drift threshold.

### CROSS-REFERENCE TO RELATED APPLICATION(S)

This application claims the benefit under 35 U.S.C. §119(a) of Korean Patent Application Nos. 10-2013-0045738, filed on Apr. 24, 2013, 10-2013-0055998, filed on May 16, 2013, and 10-2014-0047692, filed on Apr. 21, 2014, in the Korean Intellectual Property Office, the entire disclosures of which are incorporated herein by references for all purposes.

### BACKGROUND

1. Field

The following description relates to a hybrid Passive Optical Network (PON), and, more specifically to a controlling method for detecting and mitigating a rogue ONU in a hybrid PON system, such as a Time and Wavelength Division Multiplexing Passive Optical Network (TWDM PON) system which includes a tunable Optical Network Unit (ONU).

2. Description of the Related Art

As optical communication technology is advanced and the demand for the Internet service increases rapidly, fundamental research on an optical access network has been conducted since the early 2000s, and thus introduction of a broadband convergence network (which directly connects an office or a central office (CO) to subscribers through an optical fiber) such as fiber to the home (FTTH) and fiber to the office (FTTO) is generalized. Herewith, research on next generation super high-speed large-scale optical access network technology is being actively done for responding to an explosive increase in traffic due to the spread of mobile Internet protocol (IP) terminals such as smartphones or tablet computers, the commercialization of an IP television (IPTV) service, and the spread of a multimedia broadcast/streaming service over the Internet.

All around the world, numerous attempts have been made to study a new generation of an Optical Network with an increased transmission capacity, that is, an expanded network bandwidth, the increased transmission capacity which may be realized using a greater transmission distance, a greater number of divisions and limited network resources. In particular, a hybrid Passive Optical Network (PON) system is now being developed, the hybrid PON system employing both Time Division Multiplexing (TDM) technique and Wavelength Division Multiplexing (WDM) technique or/or employing Orthogonal Frequency Division Multiplexing (OFDM) technique that is used in wired/wireless communication.

For example, in the case of a Multi-Wavelength PON (MW PON) system employing both the TDM technique and the WDM technique, an Optical Network Unit (ONU) may transmit to an Optical Line Terminal (OLT) an upstream signal stream using a mixture of time and wavelength resources, thereby efficiently increasing a link capacity. Further, if the OFDM technique is employed as well, frequency resources may be utilized along with the time and wavelength resources, thereby maximizing the link capacity.

However, in a hybrid PON system, such as the TWDM PON system, which uses various types of multiplexing techniques, maintenance is regarded significantly important, compared to an existing PON system. For example, in Time Division Multiplexing Passive Optical Network (TDM PON) system, a rogue ONU is detected and mitigated in a manner that each ONU transmits an upstream signal assigned thereto within a preset period of time. However, in the TWDM PON system using both the TDM technique and the WDM technique, a rogue ONU needs to be mitigated or shut off in a manner that a rogue behavior of an ONU is detected by taking into consideration a wavelength for an upstream signal assigned to the ONU. In this case, if the ONU transmits an upstream signal using a wavelength different from the assigned wavelength, it may lead to a harmful effect on the entire system.

In particular, the TWDM PON system includes an ONU having a tunable light source, that is, a tunable ONU, so that it is possible to dynamically assign a wavelength for load balancing or rapidly change the wavelength in response to link switching. The tunable light source indicates a light source, of which output wavelength is tunable according to a value for a control parameter, so the wider a wavelength band is, the less stable the output wavelength becomes. That is, if a tunable light source is used as an optical transmitter of an ONU, the ONU is highly likely to become a rogue ONU. The possibility for the ONU to become a rogue ONU may be further higher, if an Optical Distribution Network (ODN) does not include a wavelength multiplexer, such as Arrayed Waveguide Grating (AWG).

As a way of preventing an optical power wavelength of a tunable light source of an ONU from straying away from a wavelength channel, the use of a wavelength locker may be considered. However, given the fact that a hybrid PON system is designed to provide a service to more ONUs than an existing PON system by using the same optical communication infrastructure as those of the existing PON system, adding a wavelength locker to each ONU may incur extra costs.

### SUMMARY

The following description relates to a controlling method for mitigating a rogue Optical Network Unit (ONU) in a hybrid Passive Optical Network (PON) system, such as Time Wavelength Division Multiplexing Passive Optical Network (TWDM PON) system including a tunable ONU.

In addition, the following description relates to a controlling method for mitigating a rogue ONU in a hybrid PON system, such as TWDM PON system including a tunable ONU, by rapidly selecting a rogue ONU to efficiently prevent any rogue behavior of an ONU in the entire system.

Further, the following description relates to a controlling method for mitigating a rogue ONU in a hybrid PON system, such as TWDM PON system including a tunable ONU, the controlling method which may prevent a rogue ONU from having a harmful effect on the entire system although a wavelength locker is not installed in each ONU.

In one general aspect, there is provided a controlling method for mitigating a rogue behavior of an Optical Network Unit (ONU) having a wavelength-tunable function, the controlling method comprising: operation (a) of determining whether a first wavelength for an upstream signal received from the ONU strays away from an allowable range for a second wavelength assigned to the ONU; and in response to a determination made in the operation (a) that the first wavelength strays away from the allowable range for the second wavelength, operation (b) of transmitting an upstream wavelength adjustment request message to the ONU to adjust a wavelength for the upstream signal.

The operation (a) may comprise operations comprising: operation (a1) of calculating wavelength drift of the first wavelength; and operation (a2) of determining whether the calculated wavelength drift is greater than a drift threshold. In this case, the drift threshold may be a specific value that is set as long as the specific value does not affect communication of an ONU using a third wavelength as a wavelength for an upstream signal, the third signal being adjacent to the first wavelength.

The controlling method may further include, before the operation (b), operation (c) of determining whether the upstream wavelength adjustment request message has been transmitted to the ONU greater than a predetermined number of times, wherein the upstream wavelength adjustment request message is transmitted to the ONU in the operation (b), only when a determination is made in the operation (b) that the upstream wavelength adjustment request message has been transmitted to the ONU equal or smaller than the predetermined number of times. At this point, the controlling method may further include, in response to a determination made in the operation (c) that the upstream wavelength adjustment request message has been transmitted to the ONU greater than the predetermined number of times, operation (d) of transmitting a shut-off request message to the ONU to shut off the ONU. Whether the upstream wavelength adjustment request message has been transmitted to the ONU greater than the predetermined number of times may be determined in the operation (c), by using either a number of times that the upstream wavelength adjustment request message has been transmitted consecutively or a total number of upstream wavelength adjustment request messages transmitted for a predetermined period of time.

Whether the first wavelength strays away from the allowable range for the second wavelength may be determined in the operation (a), by using change in optical power that is output as an spectral response for the received upstream signal. At this point, the controlling method may further include: operation (e) of performing optical layer supervision to determine whether there is a change in optical power of a light source provided in the ONU; and wherein the optical power output as the spectral response is used in the operation (a), when a determination is made in the operation (e) that there is no change in the optical power of the light source. Alternatively, the controlling method may further include: operation (f) of determining where there is a cause for attenuation of the upstream signal transmitted over an Optical Division Network (ODN), wherein the optical power being output as the spectral response is used in the operation (a), when a determination is made in the operation (f) that there is no cause for the attenuation of the upstream signal.

The upstream wavelength adjustment request message may include an adjustment value that indicates a degree to which the ONU adjusts the first wavelength. At this point, the adjustment value may include a differential value between the first wavelength and the second wavelength, or a change value for a control parameter controlling a wavelength for the upstream signal of the ONU, the change value corresponding to the differential value.

In still another general aspect, there is provided a controlling method for mitigating a rogue behavior of an Optical Network Unit (ONU) having a wavelength-tunable function, the controlling method comprising operations that comprise: operation (a) of receiving, at a third Optical Line Terminal (OLT), a registration request message from the ONU, which has received a first wavelength change request message from a second OLT to establish a communication link to a first OLT; operation (b) of transmitting, at the third OLT, a second wavelength change request message to the ONU to establish a communication link to the second OLT; and in response to the third OLT receiving the registration request message from the ONU more than a predetermined number of times, operation (c) of transmitting a shut-off request message to the ONU to shut off the ONU.

The operation (c) may be performed by a different OLT capable of receiving a downstream signal from the ONU through a wavelength controller which is responsible for management of wavelengths of OLTs.

In yet another general aspect, there is provided a controlling method for mitigating a rogue behavior of an Optical Network Unit (ONT) having a wavelength-tunable function, the controlling method comprising operations that comprise: operation (a) where the ONU transmits a registration request message to a second Optical Line Terminal (OLT), in response to a wavelength change request message received from a first OLT to establish a communication link to the second OLT; operation (b) where the ONU transmits the registration request message to the second OLT a predetermined number of times, in response to no response received from the second OLT for the registration request message; and operation (c) where the ONU transmits the registration request message to the first OLT in response to the registration request message being transmitted in the operation (b) to the second OLT greater than the predetermined number of times.

Other features and aspects may be apparent from the following detailed description, the drawings, and the claims.

### BRIEF DESCRIPTION OF THE DRAWINGS

FIG. 1 is a flow chart illustrating an example of a method for controlling a rogue Optical Network Unit (ONU) according to an exemplary embodiment;

FIG. 2 is a graph for explanation of a concept of a spectral response that allows only light within a specific wavelength band to penetrate;

FIG. 3A is a graph illustrating an example of a spectrum of an upstream signal received by an Optical Line Terminal (OLT), the spectrum in which wavelength drift occurs;

FIG. 3B is a diagram illustrating an example of how a rogue ONU adjusts a wavelength for an upstream signal in response to a wavelength adjustment request received in operation 15 shown in FIG. 1;

FIG. 3C is a diagram illustrating another example of how a rogue ONU adjusts a wavelength for an upstream signal in response to a wavelength adjustment request received in operation 15 shown in FIG. 1;

FIG. 4 is a diagram illustrating an example of how an ONU in a normal operation changes an existing wavelength into a different wavelength;

FIG. 5 is a diagram illustrating an example of a method for controlling a rogue ONU according to an exemplary embodiment, in a case where a tunable ONU in a normal operation becomes a rogue ONU during change of a transmission wavelength in response to a wavelength change command received from an OLT.

FIG. 6A is a message flow chart illustrating a method of how to shut off or isolate a rogue ONU according to an exemplary embodiment;

FIG. 6B is a diagram illustrating a flow chart illustrating part of the method shown in FIG. 6A;

FIG. 7A is a block diagram illustrating an example of a configuration of an ONU with a function of monitoring a wavelength for an upstream signal to be transmitted;

FIG. 7B is a graph for explanation of a principle of how an ONU detects wavelength shift of the upstream signal shown in FIG. 7A;

FIG. 8A is a diagram illustrating an example of a configuration of an ONU that is able to be used for a method for controlling a rogue ONU according to an exemplary embodiment; and

FIG. 8B is a diagram illustrating another example of a configuration of an ONU that is able to be used for a method for controlling a rogue ONU according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness. A controlling method for mitigating a rogue Optical Network Unit (ONU) according to an exemplary embodiment of the present disclosure may be applied to a hybrid Passive Optical Network (PON) system including a tunable ONU. Herein, the hybrid PON system may be a PON system that is based on both Time Division Multiplexing (TDM) technique and Wavelength Division Multiplexing (WDM) technique, that is, a Time Wavelength Division Multiplexing (TWDM) PON system. Such a hybrid PON system may be a system that adapts Orthogonal Frequency-Division Multiplexing (OFDM) technique as a communication method, or a system that does not.

A tunable ONU in the hybrid PON system provides a wavelength-tunable function. In an exemplary embodiment of the present disclosure, an ONU may provide at least a wavelength-transmitting function as a wavelength-tunable function, or may provide a wavelength-receiving function along with the wavelength-transmitting function. For example, a tunable ONU may include a tunable light source and a tunable wavelength filter. But, aspects of the present disclosure are not limited thereto. According to an exemplary embodiment of the present disclosure, there is no specific limitation in realization of a wavelength-transmitting/receiving function of an ONU.

In the hybrid PON system, a rogue behavior of an ONU may be found in various situation, including an event where an ONU transmits an upstream signal at a time slot different from a time slot assigned to the ONU in a hybrid PON system employing TDM technique, an event where an ONU transmits an upstream signal at a time slot different from a time slot assigned to the ONU in a hybrid PON system employing WDM technique, and an event where a tunable ONU transmits an upstream signal beyond a sub carrier assigned thereto in a hybrid PON system employing OFDM. A rogue behavior of an ONU may be presented as one of the above-described three events or as a combination of two out of the three events.

Hereinafter, provided are descriptions about an event where an ONU will transmit or transmits an upstream signal using a wavelength channel different than a wavelength assigned thereto. That is, in the following embodiments, a ‘rogue ONU’ indicates an ONU that will transmit or transmits an upstream signal using a wavelength different than a wavelength assigned thereto.

The rogue ONU may be seen in various scenarios. The various scenarios include a case where a possibility for an ONU to become a rogue ONU has increased significantly due to output wavelength drift of a tunable ONU that has entered into an operation state after a ranging state (Hereinafter, this case is referred to as ‘Scenario 1.’). The various scenarios include a case where a specific wavelength of an ONU, which has entered into a normal operation state using the specific wavelength, needs to be changed due to a wavelength change command received from an Optical Line Terminal (OLT) (Hereinafter, this case is referred to as ‘Scenario 2.’) In the second scenario, there is no limitation in a cause or reason for change of a wavelength of the ONU. For example, the cause or reason may be a case where the ONU is not informed of a correct wavelength map, or a case where data is set incorrectly, for example, an incorrect lookup table that defines a relation between an output wavelength and a control parameter.

In the following embodiments, a ‘method for controlling a rogue ONU’ indicates a method of mitigating a rogue ONU by detecting an ONU that will stray away or have strayed away from a wavelength assigned to the ONU. For example, the method for controlling a rogue ONU may include shutting off an ONU and/or allowing a rogue ONU to transmit an upstream signal using a wavelength channel assigned thereto.

In the exemplary embodiments of the present disclosure, three methods for controlling a rogue ONU are provided. The first method is using a communication protocol between an OLT and an ONU, the second method is allowing an ONU to monitor the current state of its own to thereby prevent a rogue behavior of the ONU in advance, and the third method is physically paring an upstream signal wavelength and a downstream signal wavelength to thereby prevent an optical output of a tunable ONU from outgoing, when there is an error in a wavelength of the optical output of the tunable ONU.

<Method of Using a Communication Protocol Between an OLT and an ONU>

For a starter, provided is a method for controlling a rogue ONU, the method whereby a possibility for a tunable ONU to become a rogue ONU is detected using a communication protocol defined for communication between an OLT and an ONU to thereby shut off the tunable ONU or enable the tunable ONU to operate properly.

Scenario 1

As described above, Scenario 1 is a case where a tunable ONU in a normal operation state will become or have become a rogue ONU due to output wavelength drift of the tunable ONU.

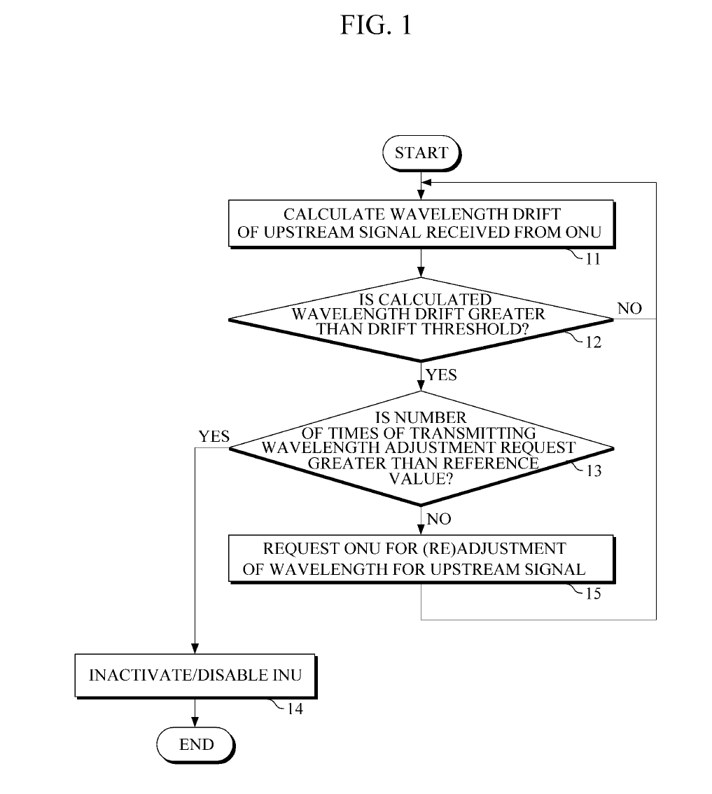

FIG. 1 is a flow chart illustrating a method for controlling a rogue ONU according to an exemplary embodiment. The method illustrated in FIG. 1 controls a rogue ONU using a communication protocol that is defined for communication between an OLT and an ONU.

Referring to FIG. 1, an OLT first calculates wavelength drift of an upstream signal received from an ONU in 11. Herein, the ‘wavelength drift’ indicates a degree or magnitude of how far the upstream signal (received from the ONU)'s wavelength has strayed away from an upstream signal's wavelength assigned to the ONU. Thus, the wavelength drift may occur not only in a case where a wavelength for the received upstream signal is greater than a wavelength for the assigned upstream signal, but also a case where a wavelength for the received upstream signal is smaller than a wavelength for the assigned upstream signal.

According to an exemplary embodiment of the present disclosure, there is no limitation in a way of how OLT calculates wavelength drift of a received upstream signal. For example, an OLT may calculate wavelength drift based on change in input intensity of a received upstream signal. Herein, the change in input intensity of a received upstream signal may be identified using the concept of a spectral response that converts input wavelength shift into relative power difference or into optical intensity difference.

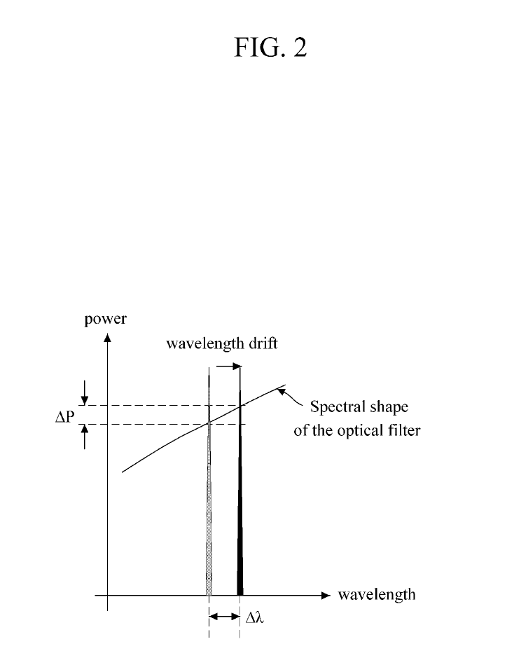

FIG. 2 is a graph for explanation of a concept of a spectral response that allows only the light within a specific wavelength band to penetrate. The spectral shape illustrated in FIG. 2 may be an optical spectral shape of Arrayed Waveguide grating (AWG) or a Thin Film Filter (TFF), which is used as a DeMUX, or may be an optical spectral shape of a linear transmittance filter.

An upstream signal is transmitted from an ONU to an OLT through a DeMUX located at the base station side or at the OLT side. The DeMUX may be an AWG Demux, a cyclinc AWG DeMUX, or a TFF Demux. At this point, each DeMUX port is designed to have a spectral response or a spectrum shape that allows only the light within a specific wavelength band to penetrate. Such a spectrum response may convert input wavelength shift into relative power difference or into optical intensity difference.

In addition, when a change (increase or decrease) in input power of an upstream signal is detected using the spectral response shown in FIG. 2, an OLT may determine that the increase/decrease in power or optical intensity of the upstream signal is led by wavelength drift of a tunable ONU. At this point, the OLT may check whether the change in power of the upstream signal is led by a different cause, and, if there is no cause of the change optical intensity of the upstream signal, may make a determination that the change in power of the upstream signal is led by wavelength drift of the tunable ONU.

The first possible cause may be a case where optical intensity output from a light source of an ONU is changed. For example, an OLT may perform transceiver parameter monitoring to determine whether optical intensity of ONU has increased or decreased, by using optical layer supervision defined in ITU-T G.984.2 AMD. If there is no change in optical intensity of the light source of the ONU, or if the change is so trivial to be ignored, a determination may be made that an increase/decrease in input intensity of an upstream signal might have been led by wavelength drift of a tunable ONU.

The second possible cause is a case when an optical signal is attenuated in the process of transmission. In this case, an OLT may identify what makes the optical intensity to be reduced in the process of transmission (for example, the transmission is performed either on an Optical Distribution Network (ODN) or on a local node), by using Optical Time Domain Reflectometer (OTDR) or by taking into consideration information on every optical signal received from a different ONU over the same ODN. For example, bending an optical fiber of an ONU may attenuate an optical signal that is to be transmitted through the bended optical fiber.

Again, referring FIG. 1, the OLT determines in operation 12 whether the ONU's wavelength drift calculated in operation 11 is greater than a drift threshold. Herein, the drift threshold may be predetermined, but there is no specific limitation therein. For example, an OLT or an operator of a corresponding hybrid PON system may set a drift threshold as long as wavelength drift of a specific ONU does not lead to an error in a different ONU using a wavelength adjacent to a wavelength of the specific ONU. A drift threshold may be referred to as Drift Of spectral/wavelength Window (DOsWi), but it is merely an example.

Operations 11 and 12 of calculating wavelength drift of an ONU and determining whether the calculated wavelength drift is greater than a wavelength drift threshold may be an exemplary operation of determining whether a wavelength for an upstream signal received from an ONU falls within a wavelength allowable range assigned to the ONU. That is, operations 11 and 12 are exemplary processes for determining whether a wavelength for an upstream signal received from an ONU is allowable, specifically, whether the wavelength for the upstream signal does not affect a different ONU using an adjacent wavelength and/or whether the wavelength for the upstream signal falls within an allowable range that is predetermined for efficient management of a system.

If it is determined in operation 12 that the calculated wavelength drift is smaller than the drift threshold, the OLT does not take a special measure on the ONU. In this case, the OLT may perform operation 11 again at a predetermined time interval to determine whether the ONU has wavelength drift and/or to calculate the wavelength drift. It is because the ONU may be considered being in a normal operation state, if the wavelength drift of the ONU is smaller than the drift threshold.

Alternatively, if it is determined in operation 12 that the calculated wavelength drift of the ONU is greater than the drift threshold, the OLT sees the ONU as a rogue ONU and takes a specific measure on the ONU. To that end, in operation 13, the OLT first determines whether the number of times that a wavelength adjustment request has been received from the rogue ONU exceeds a specific reference value. Herein, the ‘number of times that a wavelength adjustment request has been received so far’ may indicate the number of times that a wavelength adjustment request has been consecutively transmitted from the OLT to the ONU in the following operation 15 and/or the total number of wavelength adjustment requests that the OLT has transmitted to the ONU for a specific period of time. In addition, the ‘specific reference value’ may be predetermined by the OLT or by an operator of a corresponding PON system, and there is no specific limitation therein.

Then, if it is determined in operation 13, that the number of times that a wavelength adjustment request has been received exceeds a specific reference value, the OLT inactivate or disables the ONU, that is, the rogue ONU, in operation 14. To that end, the OLT may transmit a specific message to the ONU to shut off the ONU, for example, a shut-off request message and a disable Physical Layer Operation Administration and Maintenance (PLOAM) message. This operation aims to disconnect communication with the rogue ONU, in other words, to stop transmitting an upstream signal to the rogue ONU, in order to prevent an error in communication of a different ONU using a wavelength adjacent to a wavelength of the ONU. For example, if the number of times that a wavelength adjustment request has been consecutively transmitted from the OLT to the ONU exceeds a specific reference value, it means that the OLT has made consecutive attempts to adjust a wavelength of the rogue ONU, but to no avail. Thus, in this case, shutting off the rogue ONU may be helpful for the management of the system. In another example, if the total number of wavelength adjustment requests transmitted from the OLT to the ONU for a specific period of time exceeds a specific reference value, it means that the ONU has become a rogue ONU, although a wavelength thereof has been adjusted. Thus, even in this case, shutting off the rogue ONU may be helpful for management of the system.

Alternatively, if it is determined in operation 13 that the number of times that a wavelength adjustment request has been received so far does not exceed a specific reference value, the OLT may request the rogue ONU for adjustment of a wavelength for an upstream signal in operation 15. To that end, the OLT may transmit a wavelength adjustment message or a wavelength tuning message in a specific format to the rogue ONU. In this embodiment, there is no limitation in a format of the wavelength adjustment message. In addition, there is no limitation in a name of the wavelength adjustment message. For example, the wavelength adjustment message may be an upstream wavelength adjustment request message.

For example, the OLT may, periodically or when necessary, use one of messages transmitted to the ONU as an upstream wavelength adjustment request message in order to maintain manage the entire network. Examples of the messages transmitted from the OLT to the ONU include a PLOAM message defined in ITU-T G.989.3, an embedded Operation Administration and Maintenance (OAN) channel message, and an ONT Management & Control Interface (OMCI) channel message that will be newly defined in ITU-T G.988. Alternatively, as a wavelength adjustment message, the OLT may use a message in a new format other than the existing messages used so far.

According to one aspect of the embodiment, the wavelength adjustment message that the OLT transmits to the rogue ONU in operation 15 may include not only information on a command or request for change of a wavelength of the ONU, but also an adjustment value for a control parameter, which is information on a degree to which the ONU changes or adjusts a wavelength thereof. For example, as the control parameter, the wavelength adjustment message may include the wavelength drift calculated in operation 11 or a corresponding change value of a control parameter. Alternatively, the wavelength adjustment message may include not only the wavelength drift calculated in operation 11, but also a specific value for a control parameter, which is determined by taking into consideration other conditions, such as information on a wavelength to be changed and a corresponding change value of a control parameter.

If the OLT requests the rogue ONU for adjustment or readjustment of a wavelength for an upstream signal in operation 15, the OLT repeatedly performs operations 11 to 15 with respect to the corresponding ONU. In this manner, the OLT may check whether a rogue ONU adjusts or corrects a wavelength for an upstream signal in response to receipt of a wavelength adjustment request message. In addition, by repeatedly performing operations 11 to 15, the OLT allows the rogue ONU to transmit an upstream signal using a wavelength as correct to a wavelength assigned thereto as possible. For example, the above operation may be performed by checking whether optical intensity of an upstream signal that an OLT receives is maximized.

Although not illustrated in the drawings, in a case where an ONU has adjusted a wavelength for an upstream signal in response to a wavelength adjustment request message, the ONU may transmit to an OLT a message notifying completion of the adjustment of the wavelength. It aims to notify the OLT of completion of the adjustment of the wavelength of the ONU, thereby enabling the OLT to more efficiently manage the system. Thus, the above-described process may be more efficient than a case where it takes a relatively long time to tune a tunable light source of an ONU, that is, a tunable laser.

Using the above-described controlling method for mitigating a rogue ONU, it is possible to adjust a wavelength for an upstream signal of a rogue ONU through exchange of messages between an OLT and an ONU without adding a new device to a hybrid PON system. That is, in this embodiment, an output wavelength of a tunable ONU may be tuned to a center wavelength of a DeMUX with messages being exchanged between an OLT and an ONU, and thus, it may be an efficient method for mitigating a rogue ONU.

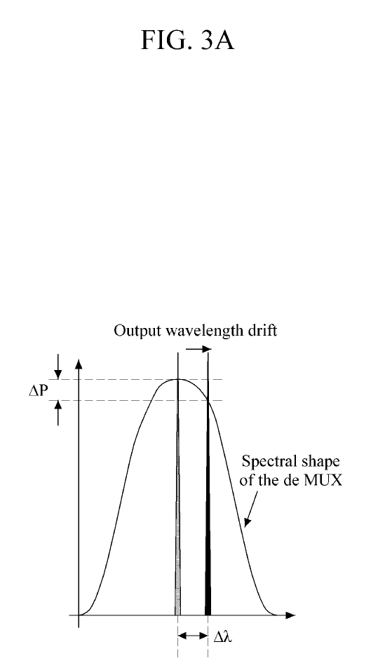

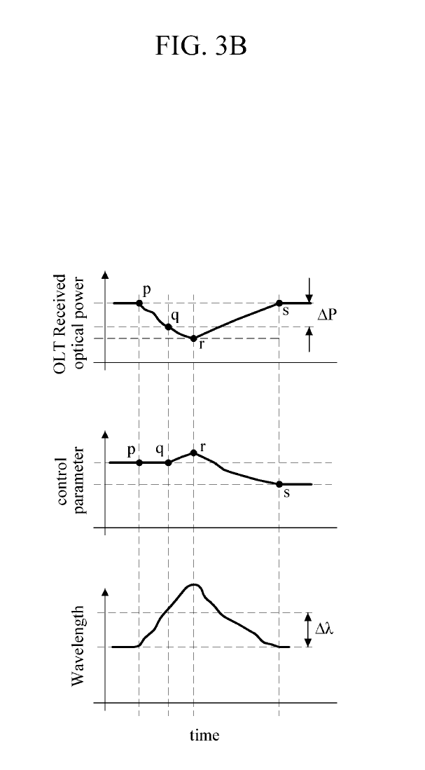

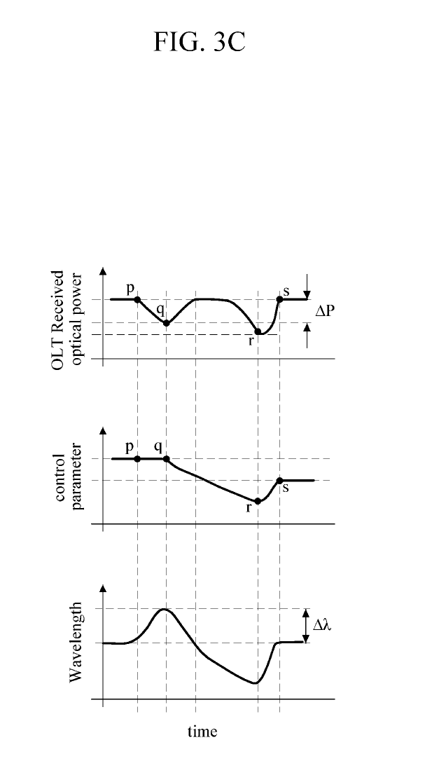

FIG. 3 is a graph illustrating an example of a spectrum of an upstream signal that the OLT receives, the spectrum in which wavelength drift with a specific magnitude occurs. The graph shown in FIG. 3A may be an example of a spectral shape of a DeMUX provided at the OLT side in a hybrid PON system. Referring to FIG. 3A, an upstream signal may has wavelength drift with a specific magnitude Δλ, and accordingly, there is a difference with the specific magnitude Δλ between output and maximum output.

FIGS. 3B and 3C are diagrams illustrating examples of how a rogue ONU adjusts a wavelength for an upstream signal in response to a wavelength adjustment request message that is received in operation 15. Both in FIGS. 3B and 3C, the top graph indicates a change in received optical power of an OLT over time, the mid graph indicates a change in a magnitude of a control parameter of an OLT over time, and the bottom graph indicates a change in a wavelength over time.

Referring to FIGS. 3B and 3C, a point q or a corresponding point of time indicates a point or a point of time at which an OLT detects reduction in power of a received upstream signal. In response to the detection, the OLT transmits to an ONU a wavelength adjustment message, that is, a wavelength adjustment request. In response to receipt of the wavelength adjustment request, the ONU adjusts an output wavelength by changing a value for a control parameter slightly. FIG. 3B relates to a case in which a value of a control parameter increases, and FIG. 3C relates to a case in which a value of a control parameter decreases. In addition, both in FIGS. 3B and 3C, each of the points q, r and s indicates a point or a point of time at which a value for a control parameter is changed in response to a wavelength adjustment request.

Scenario 2

As described above, Scenario 2 is about an event where a tunable ONU in a normal operation state will become or have become a rogue ONU during change of a transmission wavelength in response to a wavelength change command received from an OLT. Hereinafter, before a method for controlling a rogue ONU according to an exemplary embodiment of the present disclosure, a procedure of how an ONU in a normal operation state changes the current wavelength into a different wavelength is described.

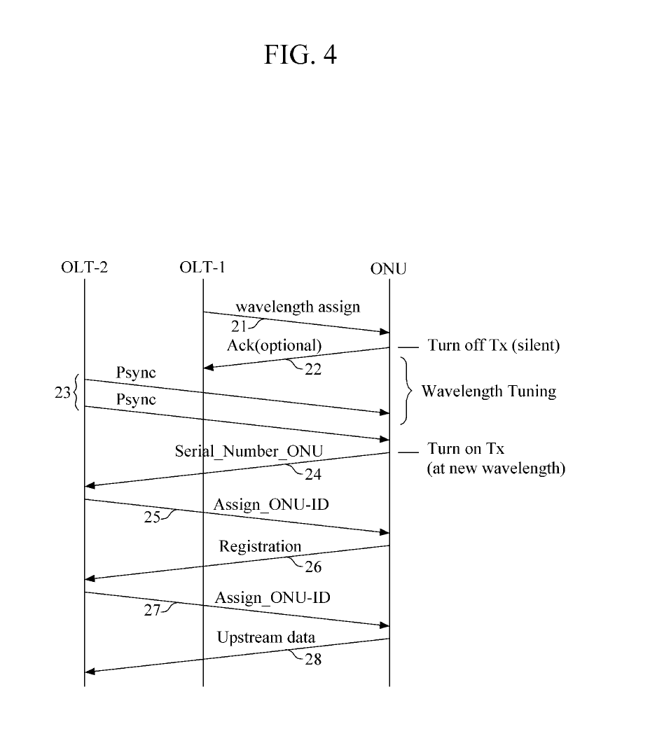

FIG. 4 illustrates an example of a procedure of how an ONU in a normal operation state changes the current wavelength into a different wavelength, specifically, how an ONU in communication with the first OLT (OLT-1) establishes a communication link to the second OLT (OLT-2). Herein, there is no specific limitation in a reason that makes the ONU establish a communication link to the second OLT (OLT-1) instead of the first OLT (OLT-1).

Referring to FIG. 4, the first OLT (OLT-1) in communication to the ONU transmits a wavelength change command or a wavelength change request message to the ONU in operation 21. The wavelength change command may be a PLOAM message that instructs new wavelength assignment for the ONU. To that end, the wavelength change command may include ONU identification (ONU_ID) of the ONU which has received the wavelength change command, information on wavelengths (that is, upstream and downstream signal wavelengths) to be assigned, and information that indicates whether to roll back to the default wavelength when wavelength change is not performed properly. For example, the wavelength change command may include a PLOAM message that includes upstream and downstream signal wavelengths to be changed by the ONU. The PLOAM message may be a PLOAM message called wavelength-change or wavelength-assign, which is defined in the ITU-T G.989.3, but it is merely exemplary.

In operation 22, in response to receipt of the wavelength change command (e.g. a tuning_control (request) PLOAM message), the ONU may transmits to the first OLT (OLT-1) a response message, for example, an ACK message notifying that the ONU would follow the wavelength change command and a NACK message notifying that the ONU would decline the wavelength change command. For example, the response message may include a tuning_Response PLOAM message. In addition, the ONU may shut off a tunable filter Tx, that is, a laser.

If the ONU in communication with the first OLT (OLT-1) receives a command for establishing a communication link to the second OLT (OLT-2), the ONU receives from the second OLT (OLT-2) a specific message Psync, which is periodically transmitted from the second OLT (OLT-2) for synchronization. At this point, in response to receipt of the wavelength change command, the ONU receives the specific message Psync by tuning a wavelength thereof and secures synchronization in a physical layer for a purpose of alignment of a tunable filter of a tunable receiver to the downstream signal wavelength received in operation 21.

The ONU turns on the tunable transmitter Tx (that is, the laser) to transmit an optical signal using a new upstream signal wavelength. To notify completion of the change of the wavelength, the ONU may transmits to the second OLT a notification message, for example, a Tuning_Response(Complete_u) PLOAM message. In response, the second OLT transmits a Tuning_Response(Complete_d) PLOAM message to the ONU to notify completion of the change of the wavelength. The following operation may be a similar version or a simplified version of how registration process is performed in a 10-Gigabit-capable Passive Optical Network (XG-PON) system. After the following operation, for example, a registration process, ends, the second OLT may start exchanging messages with the ONU for communication.

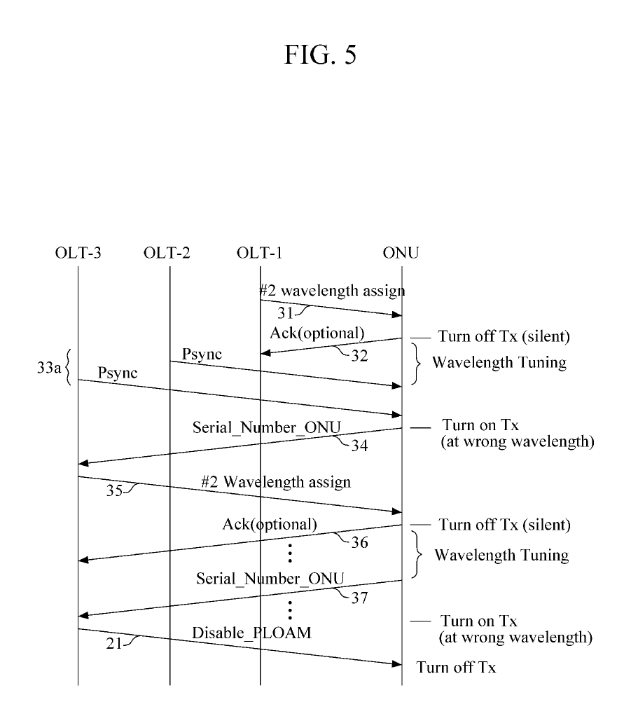

Then, provided is a method for controlling a rogue ONU in the case where an ONU attempts to register to an OLT different from a newly assigned OLT during change of a transmission wavelength in response to a wavelength change command received from an OLT. FIG. 5 illustrates an example of the above-described case. Specifically, FIG. 5 illustrates an example in which ONU being in a normal operation state and in communication with the first OLT (OLT-1) attempts to establish a communication link to the third OLT (OLT-3) despite a command that instructs the ONU to establish a communication link to the second OLT (OLT-2). As described above, the embodiment of the present disclosure does not specifically limit a cause or reason that the ONU attempts to establish a communication link to the third OLT (OLT-3) despite a command that instructs to establish a communication link to the second OLT (OLT-2). For example, it may be because of an incorrect wavelength map which the ONU has received from the first OLT (OLT-1) and/or because of an incorrect lookup table defining a relation between a control parameter and an output wavelength.

Referring to FIG. 5, the first OLT (OLT-1) in communication with an ONU transmits to the ONU a wavelength change command or a wavelength change request message in operation 31. The wavelength change command may be a Tuning_Control(Request) message that instructs new wavelength assignment for the ONU. In response to receipt of the wavelength change command, the ONU transmits an Ack message to the first OLT (OLT-1) in operation 32. The ONU may shut off a tunable transceiver Tx.

In operation 33, in response to receipt of a command instructing to establish a communication link to the second OLT (OLT-2), the ONU tunes a receivable wavelength band of a tunable filter of a tunable receiver to a downstream wavelength channel of the second OLT (OLT-2) to receive a specific message Psync that is periodically transmitted from the second OLT (OLT-2) for synchronization. However, the tunable filter of the tunable receiver of the ONU is not tuned to a downstream wavelength channel of the third OLT (OLT-3), rather than that of the second OLT (OLT-2), due to an incorrect wavelength map. At this point, the third OLT (OLT-3) may also be transmitting the specific message Psync for synchronization with ONUs that will be newly registered in the PON. In operation 34, the ONU may transmit a Tuning_Response(Complete_u) PLOAM message to the third OLT (OLT-3) to notify completion of the change of a wavelength, since the ONU is not capable of distinguishing the second OLT (OLT-2) and the third OLT (OLT-3). In this case, the third OLT (OLT-3) may allow the ONU to register thereto, or may not able to allow the ONU to register thereto for some reasons. If the OLT is not able to allow the corresponding ONU to register thereto, the third OLT (OLT-3) may recommend the ONU to roll back to the existing OLT (the first OLT). If the ONU rolls back to the current OLT (the first OLT), the third OLT (OLT-3) may transmits a Tuning_Response9Rollback message to the first OLT (OLT-1) in operation 35.

As described above, a rogue behavior of an ONU may occur due to an incorrect wavelength map received from an OLT or due to an incorrect lookup table defining a relation between a control parameter and an output wavelength. As described above with reference to FIG. 5, in a case where an ONU being in a normal operation state and in communication with the first OLT (OLT-1) exhibits a rogue behavior, and thus, attempts to register to the third OLT (OLT-3) based on an incorrect lookup table despite a wavelength change command instructing to shift to the second OLT (OLT-2), the ONU may periodically transmit a Serial_number)ONU PLOAM message to the third OLT (OLT-3) during a quite window of the third OLT (OLT-3) until the third OLT (OLT-3) allows the registration. Nonetheless, the ONU continues attempting to register to the third OLT (OLT-3) based on the lookup table, and, in this case, the third OLT (OLT-3) may disable the ONU by transmitting a disable PLOAM message to the ONU.

The above-described operation is about an example in which an ONU has changed a wavelength of a tunable receiver to receive a downstream signal wavelength of the second OLT (OLT-2) in response to a wavelength change command that instructs to shift to the second OLT (OLT-2), but transmits an upstream signal wavelength to the third OLT (OLT-3) due to an incorrect lookup table. That is, the above-described operation is performed in the assumption that quite windows of the second OLT (OLT-2) and the third OLT (OLT-3) are synchronized. However, the quite windows of the second OLT (OLT-2) and the third OLT (OLT-3) may not be synchronized. In such a case, if a rogue ONU continues transmitting a message (e.g. Serial_number_ONU) for registration, it may lead to a collision with an upstream signal transmitted from a different ONU to the third OLT (OLT-3).

In order to solve the above problem, the third OLT (OLT-3) may identify the second OLT (OLT-2) capable of transmitting a disable PLOAM message to the rogue ONU, by notifying a wavelength controller, which is responsible for management of wavelengths of OLTs, of the current state of its own, and then may transmit a disable PLOAM message to the rogue ONU via the second OLT (OLT-2) to thereby shut off the rogue ONU. However, in the case where there are a plurality of OLTs or a plurality of OLT ports, it may take a long time to transmit the disable PLOAM message to the rogue ONU via a certain OLT.

Just like the above described rogue behavior of an ONU, if a downstream signal wavelength receiving SN_grant does not correspond to an upstream signal wavelength transmitting Serial_number_ONU when an ONU makes the first attempt to register to a PON system, a rogue ONU may not have even a serial number or ONU-ID. In this case, an OLT with a collision may shut off ONUs registered therein, or may transmit a wavelength change command instructing to change into a different wavelength. Then, the OLT may identify the rogue ONU, and transmit a disable PLOAM message to the rogue ONU through a wavelength channel which is capable of transmitting a command to the rogue ONU.

As described above, if a downstream signal wavelength and an upstream signal wavelength of an ONU do not correspond to each other (that is, a case where an OLT transmitting a downstream signal is different from an OLT transmitting an upstream signal) or if an ONU attempting to register to the PON system becomes a rogue ONU, it is necessary to shut off or isolate the rogue ONU.

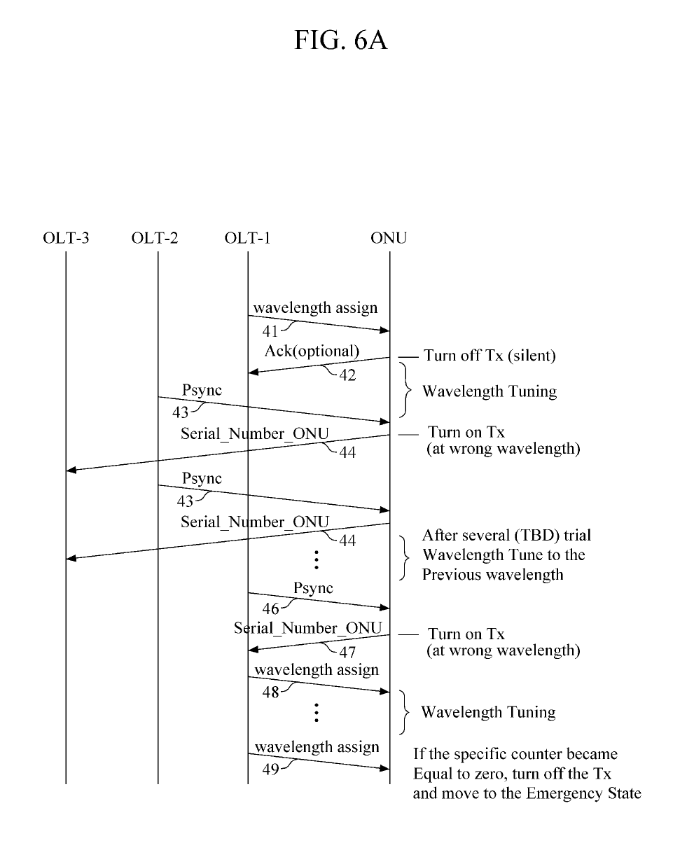

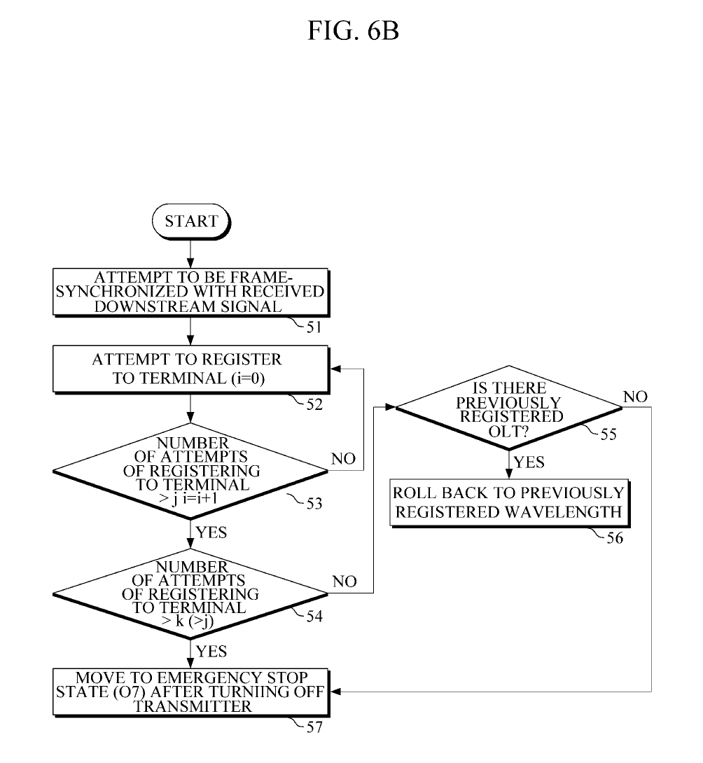

FIG. 6 is a message flow chart illustrating an example of how to shut off or isolate a rogue ONU according to an exemplary embodiment. Descriptions about messages transmitted and received between an ONU and an OLT in each operation in the flow chart shown in FIG. 6A may be the same as those provided above with reference to FIGS, and thus, details thereof is herein omitted.

Referring to FIG. 6A, in response to receipt of a request for changing to a new wavelength channel with a new wavelength assigned by the first OLT (OLT-1), an ONU may transmit an Ack message to the first OLT (OLT-1) in operation 41 and 42. In operation 43, the ONU is synchronized with a synchronization signal Psync transmitted from the second OLT (OLT-2) to thereby receive a downstream signal from the second OLT (OLT-2). However, in operation 44, the ONU transmits, to a different OLT, for example, the third OLT (OLT-3), a Tuning_Response(Complete_u) PLOAM message notifying completion of the change of a wavelength as a way of requesting registration. In this embodiment, the number of times that the ONU has transmitted to an OLT a response message notifying completion of the change of the wavelength, for example, a Tuning_Response(Complete_u) PLOAM message, is counted. If the ONU has transmitted to the second OLT (OKT-2) the Tuning_Response(Complete_u)PLOAM message more than a specific number of times, but fails to receive a Complete_d PLOAM message from the second OLT (OKT-2), the ONU no longer transmits the Tuning_Response(Complete_u)PLOAM message. Instead, the ONU goes back to the existing first OLT (OLT-1) in operation 46, and rolls back to the first OLT (OLT-1) to notify the current state using a Tuning_Response(Rollback) message in operation 46. If the ONU rolls back to the first OLT (OLT-1), the first OLT (OLT-1) requests a new wavelength using a Tuning_Control(Request) PLOAM message in operation 48, the new wavelength using which the ONU is able to establish a communication link to a new OLT. Then, the ONU may perform operations 43 to 45 repeatedly, and, in response to a failure to register to the new OLT, may roll back to the first OLT (OLT_1) again. As such, if an ONU has performed the registration process more than a specific number of times despite receipt of a wavelength change request, the first OLT (OLT-1) determines that the ONU is highly likely to become a rogue ONU, and thus, transmits a Disable PLOAM message to the ONU, so that the first OLT (OLT-1) renders the ONU into an emergency stop state in operation 49.

To that end, the number of times that a registration request message (e.g. Tuning_Response(Complete_u)), shown in the following Table 1, has been received or the number of attempts for transmission of the registration request message may be counted, and then the counted number of times may be used as data when determining whether the ONU is a rogue ONU. In this case, counting the number of times of attempts of transmission of the registration request message needs to be an essential function of the ONU. According to an exemplary embodiment, data on the number of transmission of the registration request message may be used as resources for indication of an occurrence of a relevant event.

TABLE 1

| | | | Collected | Collected | |
|---|---|---|---|---|---|
| | Mandatory | | by each | by each OLT | Collected |
| Parameter | or optional | Description | ONU | for each ONU | by OLT |
| Tuning_Response\|Complete_u) | M | Note that the count is | Yes | Yes | Yes |
| | | mandatory as it | | | |
| | | mitigates Rouge | | | |
| | | ONUs | | | |

FIG. 6B is a flow chart illustrating some operations in the method described above with reference to FIG. 6A. That is, FIG. 6B is a flow chart illustrating an example of a method for controlling a rogue ONU according to an exemplary embodiment.

Referring to FIG. 6B, an ONU attempts to be frame-synchronized with a downstream signal that is received from a newly changed OLT, in operation 51 which corresponds to operation 43 in FIG. 6A. Then, the ONU attempts to register to the new OLT in operation 52 which corresponds to operation 43 shown in FIG. 6A. The number (i) of the attempts for registration is compared with the specific first reference number of times (j) in operation 53. If the number (i) is smaller than the first reference number of times (j), operation 52 is performed again. Alternatively, if the number (i) is smaller than the first reference number of times (j), the number (i) is compared with the second reference number of times (k) in operation 54. If the number (i) is smaller than the second reference number of times (k), whether the ONU has been registered in any OLT is determined in operation 55. If it is determined in operation 55 that the ONU has been registered in any OLT, the ONU goes back to a wavelength of the currently registered OLT in operation 56. Alternatively, if it is determined in operation 55 that the ONU has not registered to any OLT, or if it is determined in operation 54 that the number (i) is greater than the second reference number of times (k), the ONU is rendered into an emergency stop state in operation 57. The following Table 2 demonstrates an example of an ONU in an activation state based on the above flow.

TABLE 2

| | ONU activation state | | | | | |
|---|---|---|---|---|---|---|
| | | Serial | | | Intermittent | Emergency |
| | Initial | Number | Ranging | Operation | LODS | Stop |
| Event | O1 | O2-3 | O4 | O5 | O6 | O7 |
| Failure of correction | | ===> O7 | ===> O7 | ===> O7 | ===> O7 | |
| by ONU (expired | | | | | | |
| timer or exceed of | | | | | | |
| number of attempts | | | | | | |
| for registration | | | | | | |

According to one aspect of the embodiment, before installation of a tunable ONU, in order to efficiently isolate a rogue ONU, an installer may set a default wavelength value that is to be used upon power being applied to an ONU. (according to an operator's management policy). In this case, setting a default wavelength value needs to be performed by the ONU as an essential function. Herein, the default wavelength value may be either a control value which is necessary for a tunable receiver to receive a downstream signal or a control value which is necessary for the tunable receiver to transmit a upstream signal, or both of them. In addition, to that end, a default control value may be stored in a nonvolatile memory using Dip switch, Joint Test Action Group (JTAG) or 2-wire serial interface.

<Method Whereby an ONU Monitors the Current State of its Own>

Hereinafter, provided is a method of controlling a rogue ONU, the method whereby an ONU monitors the current state of its own to detect a possibility for a tunable ONU to become a rogue ONU, and accordingly, shuts off the rogue ONU and/or enables a rogue ONU to operate properly. Using the method of controlling a rogue ONU according to this embodiment, an ONU monitors a wavelength for an upstream signal transmitted from itself, and, if necessary, corrects the upstream signal wavelength, thereby mitigating a rogue ONU.

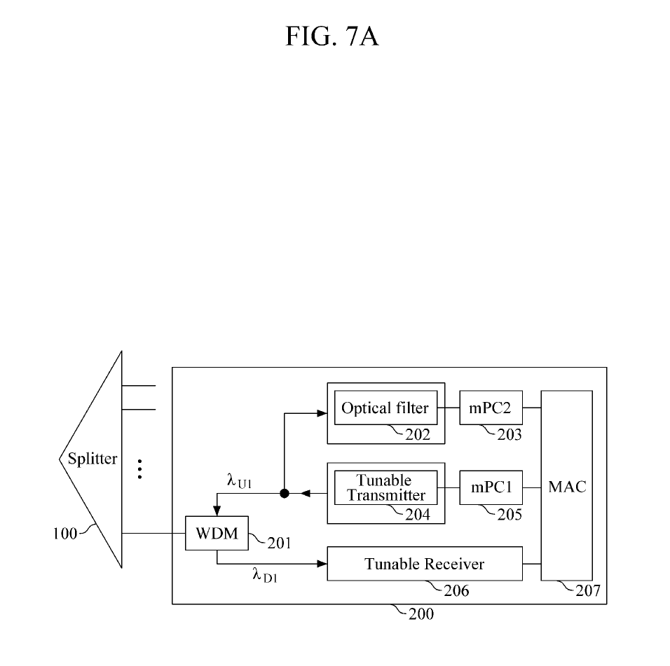

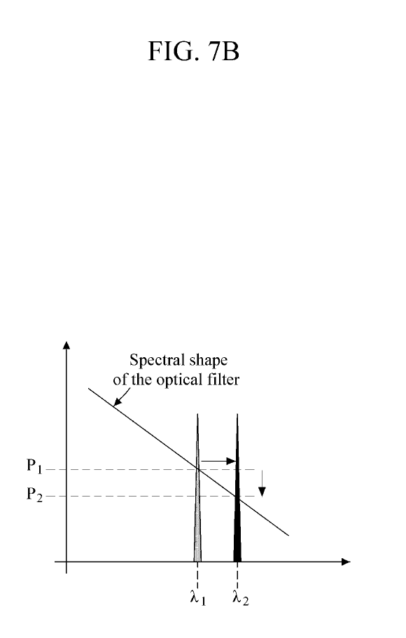

FIG. 7A is a block diagram illustrating an example of an ONU with a function of monitoring a wavelength for an upstream signal transmitted from itself. Reference number 100 in FIG. 7A indicates a splitter installed at the ONU side on an ODN, and reference number 200 indicates an ONU according to an exemplary embodiment of the present disclosure. In addition, FIG. 7B is a graph for explanation of a principle of how to detect wavelength shift of an upstream signal, that is, change of an output wavelength, which is transmitted from an ONU. FIG. 7B demonstrates a straight-line spectrum of an optical filter, but it is apparent to those skilled in the art that the straight-line spectrum of an optical filter is merely exemplary. Referring to FIG. 7A, an ONU 200 includes a wavelength division multiplexing (WDM) 201, an optical filter 202, such as a linear transmittance filter, the second monitor photo diode (mPD2) 203, a tunable transmitter 204, the first monitor photo diode (mPD1) 205, a tunable receiver (206), and a Medium Access Control (MAC) 207.

The ONU 204 may monitor the current state of its own by allowing part of output from the tunable transmitter 204 to penetrate the optical filter 202, such as a linear transmittance filter, and then comparing a value of the mPD2 203 with a value of the mPD1 205 embedded in the tunable transmitter 204. That is, the ONU 200 may monitor a wavelength of its own by allowing part of output from the tunable transmitter 204 to penetrate the optical filter 202, such as the linear transmittance, while converting wavelength shift into a relative power value. If the transmitted wavelength is wrong, in other words, if the ONU has become a rogue ONU, the ONU corrects the error by itself to return back to a normal operation state.

With reference to FIGS. 7A and 7B, the principle of how to monitor an output wavelength of the tunable transmitter 204 of the ONU 200 is described in detail as below. FIG. 7B is a graph explaining an example in which power in a spectral shape of a specific optical filter 202 is changed in response to change of a wavelength. Specifically, when an output wavelength of the tunable transmitter is changed from wavelength 1 λ1 to wavelength 2 λ2, the mPD1 205 embedded in the tunable transmitter 204 reads the same value; however, the mPD2 203 detecting output of the optical filter 202 reads P2, rather than P1. By comparing the value of the second mPD2 203 with a value of the mPD1 205, whether a wavelength of the tunable transmitter 204 has drifted may be determined. If so, it is also possible to identify which direction the wavelength drift is made toward. An output wavelength of the tunable transmitter 204 is adjusted based on such information, thereby preventing the ONU 200 from becoming a rogue ONU or enabling a rogue ONU to operate properly.

The optical filter 202, such as a linear transmittance filter, used herein may be obtained by designing or manufacturing a multiple-layered to have a specific number of layers and a specific thickness value with a slope of desired within a wavelength band of desire, just like a gain flattening filter. A wavelength band of an optical filter should be set in consideration of a wavelength tunable band of a corresponding tunable transmitter, and a slope of the filter may be set by resolution that aims to detect wavelength shift.

According to the exemplary embodiment, the tunable ONU 200 needs to be able to turn on the tunable transmitter 204; however, in this case, the ONU 200 is highly likely to exhibit a rogue behavior. To prevent the rogue behavior, the ONU 200 may be set to turn on the tunable transmitter 204 during a quite window of an OLT. Alternatively, the ONU may be controlled not to affect an OLT by keeping output power of a light source below a specific value.

According to one aspect of this embodiment, it is desirable to update the ONU, specifically, a lookup table embedded in the tunable transmitter, the lookup table which defines a relation between a control parameter and a wavelength of an output light. In such a case, it is desirable that the ONU 200 is allowed to correct a wavelength of an output light by itself based on the updated lookup table.

In addition, if any rogue behavior of the ONU 200 is detected but the ONU 200 does not correct the wavelength of an output light by itself within a specific period of time, an OLT may render the ONU 200 into an emergency stop state, as shown in the above Table 3, or the ONU 200 may enter into an emergency stop state by itself. In the latter case, using Ind field of an XGTC header, an ONU with a specific serial number may notify an OLT of an event that the ONU has entered into an emergency stop state.

According to another aspect of the embodiment, as an OLT and an OLT exchange a PLOAM message including a relative wavelength value obtained using the optical filter 202, such as a linear transmittance filter, wavelength channel information of an OLT may become conforming to wavelength channel information on an ONU. At this point, the ONU may undergo wavelength learning, similar to the case where an ONU undergoes burst pattern learning in an existing PON system (e.g. an XG-PON system).

<Method of Physically Paring an Upstream Signal Wavelength and a Downstream Signal Wavelength of an ONU>

Hereinafter, provided is a method for controlling a rogue ONU in a case where a tunable ONU has become a rogue ONU, by physically paring an upstream signal wavelength and a downstream signal wavelength of the ONU. The method for controlling a rogue ONU according to this embodiment prevents an ONU from becoming a rogue ONU, by preventing a wrong wavelength for an output signal of a tunable ONU or preventing an optical power with a wrong wavelength from outgoing.

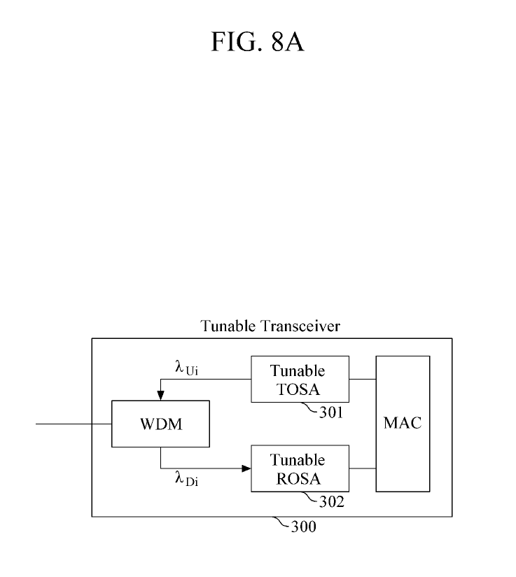

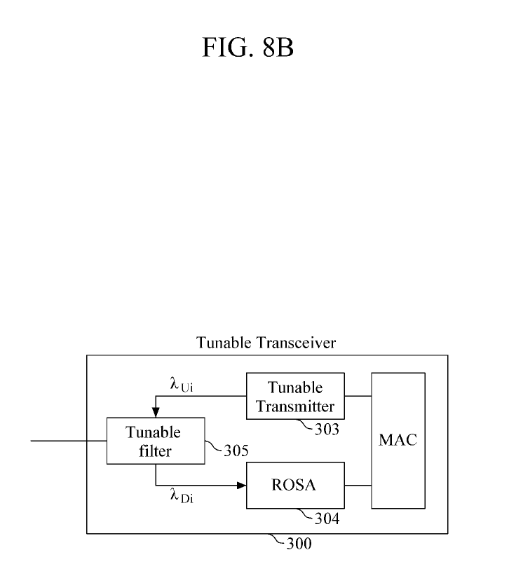

FIG. 8A is a diagram illustrating an ONU, specifically, a tunable transreceiver of an ONU, which is able to be used for the method for controlling a rogue ONU according to an exemplary embodiment. Referring to FIG. 8A, an ONU 300a includes a WDM, a tunable receiver 301, such as a tunable Receive Optical Sub-Assembly (ROSA), a tunable transmitter 302, such as a tunable Transmit Optical Sub-Assembly (TOSA), and an MAC.

Physically pairing an upstream signal wavelength and a downstream signal wavelength of the ONU 300a is performed in the assumption that the both wavelengths are in a preset relation. That is, the upstream signal wavelength and the downstream signal wavelength need to be located at specific wavelength spacing. In this case, a control parameter controlling a filter of the tunable receiver 302 of the ONU 300a needs to be move along or to be fixed with a control parameter determining an output wavelength of the tunable transmitter 301. At this point, in a case where a filter of the tunable receiver 302 is assigned a downstream signal wavelength for synchronization with a downstream signal, an output of the tunable transmitter 301 is automatically assigned an upstream signal wavelength that is paired with the downstream signal wavelength.

However, although the method of controlling a rogue ONU is employed using the ONU 300a configured as shown in FIG. 8A, it is impossible to fundamentally prevent a rogue behavior of the tunable transmitter 301. FIG. 8B is an example of a configuration of an ONU to prevent such a drawback. Using an ONU 300b configured as shown in FIG. 8B may prevent output of an upstream signal with a wrong wavelength. Referring to FIG. 8B, the ONU 300b includes a tunable filter 305, an optical receiver 304, such as a ROSA, and a tunable transmitter 303.

According to this embodiment, the tunable filter needs to be designed to be cyclic in accordance with a preset wavelength relation between a wavelength band of an upstream signal and a wavelength band of a downstream signal. The tunable filter 305 may be a filter characterized by being cyclic or Free Spectral Range (FSR), and may include a cyclic AWG and an etalon filter. In addition, the tunable filter 305 may be a filter with multiple tunable bragg grating filters being consecutively arranged therein in serial or in parallel, in which wavelength may be tunable mechanically or using a thermo-optical effect.

According to one aspect of the embodiment, the ONU 300b may be realized as a combination of the tunable filter 305 shown in FIG. 8B and the WDM 201 (See FIG. 7A). In this case, instead of an additional tunable receiver, a general tunable receiver may be applied.

According to the above-described embodiments, in a case where an upstream signal wavelength for an ONU drifts in a hybrid PON system including a tunable ONU or a case where an ONU transmits an upstream signal using a wavelength different from a wavelength assigned thereto, and thus, becomes a rogue ONU, the ONU is enabled to operate properly or shut off by exchanging, with an OLT, messages which are in accordance with a communication protocol defined between the ONU and the OLT. In this manner, it is possible a harmful effect that the rogue ONU may have on the system.

Those who are skilled in the related art may understand that various and specific modifications may be made without modifying the technical ideas or essential characteristics of the invention. Accordingly, the embodiments disclosed above are exemplary, and should be understandable not to be limited to in all aspects.

What is claimed is:

1. A controlling method for mitigating a rogue behavior of an Optical Network Unit (ONU) having a wavelength-tunable function, the controlling method comprising:
operation (a) of determining whether a first wavelength for an upstream signal received from the ONU strays away from an allowable range for a second wavelength assigned to the ONU; and
in response to a determination made in the operation (a) that the first wavelength strays away from the allowable range for the second wavelength, operation (b) of transmitting an upstream wavelength adjustment request message to the ONU to adjust a wavelength for the upstream signal.

2. The controlling method of claim 1, wherein the operation (a) comprises operations comprising:
operation (a1) of calculating wavelength drift of the first wavelength; and
operation (a2) of determining whether the calculated wavelength drift is greater than a drift threshold.

3. The controlling method of claim 2, wherein the drift threshold is a specific value that is set as long as the specific value does not affect communication of an ONU using a third wavelength as a wavelength for an upstream signal, the third signal being adjacent to the first wavelength.

4. The controlling method of claim 1, further comprising:
before the operation (b), operation (c) of determining whether the upstream wavelength adjustment request message has been transmitted to the ONU greater than a predetermined number of times,
wherein the upstream wavelength adjustment request message is transmitted to the ONU in the operation (b), only when a determination is made in the operation (b) that the upstream wavelength adjustment request message has been transmitted to the ONU equal or smaller than the predetermined number of times.

5. The controlling method of claim 4, further comprising:
in response to a determination made in the operation (c) that the upstream wavelength adjustment request message has been transmitted to the ONU greater than the predetermined number of times, operation (d) of transmitting a shut-off request message to the ONU to shut off the ONU.

6. The controlling method of claim 4, wherein whether the upstream wavelength adjustment request message has been transmitted to the ONU greater than the predetermined number of times is determined in the operation (c), by using either a number of times that the upstream wavelength adjustment request message has been transmitted consecutively or a total number of upstream wavelength adjustment request messages transmitted for a predetermined period of time.

7. The controlling method of claim 1, wherein whether the first wavelength strays away from the allowable range for the second wavelength is determined in the operation (a), by using change in optical power that is output as an spectral response for the received upstream signal.

8. The controlling method of claim 7, further comprising:
operation (e) of performing optical layer supervision to determine whether there is a change in optical power of a light source provided in the ONU; and
wherein the optical power output as the spectral response is used in the operation (a), when a determination is made in the operation (e) that there is no change in the optical power of the light source.

9. The controlling method of claim 7, further comprising:
operation (f) of determining where there is a cause for attenuation of the upstream signal transmitted over an Optical Division Network (ODN),
wherein the optical power being output as the spectral response is used in the operation (a), when a determination is made in the operation (f) that there is no cause for the attenuation of the upstream signal.

10. The controlling method of claim 1, wherein the upstream wavelength adjustment request message comprises an adjustment value that indicates a degree to which the ONU adjusts a wavelength for the upstream signal.

11. The controlling method of claim 10, wherein the adjustment value comprises a differential value between the first wavelength and the second wavelength, or a change value for a control parameter controlling a wavelength for the upstream signal of the ONU, the change value corresponding to the differential value.

12. A controlling method for mitigating a rogue behavior of an Optical Network Unit (ONU) having a wavelength-tunable function, the controlling method comprising operations that comprise:
operation (a) of receiving, at a third Optical Line Terminal (OLT), a registration request message from the ONU, which has received a first wavelength change request message from a second OLT to establish a communication link to a first OLT;
operation (b) of transmitting, at the third OLT, a second wavelength change request message to the ONU to establish a communication link to the second OLT; and
in response to the third OLT receiving the registration request message from the ONU more than a predetermined number of times, operation (c) of transmitting a shut-off request message to the ONU to shut off the ONU.

13. The controlling method of claim 12, wherein the operation (c) is performed by a different OLT capable of receiving a downstream signal from the ONU through a wavelength controller which is responsible for management of wavelengths of OLTs.

14. A controlling method for mitigating a rogue behavior of an Optical Network Unit (ONT) having a wavelength-tunable function, the controlling method comprising operations that comprise:
operation (a) where the ONU transmits a registration request message to a second Optical Line Terminal (OLT), in response to a wavelength change request message received from a first OLT to establish a communication link to the second OLT;
operation (b) where the ONU transmits the registration request message to the second OLT a predetermined number of times, in response to no response received from the second OLT for the registration request message; and
operation (c) where the ONU transmits the registration request message to the first OLT in response to the registration request message being transmitted in the operation (b) to the second OLT greater than the predetermined number of times.
